(19) United States
(12) Patent Application Publication
(10) Pub. No.: US 2019/0131060 A1
(43) Pub. Date: May 2, 2019

(54) INDUCTOR WITH CONDUCTIVE ADHESIVE COIL CONDUCTOR

(71) Applicant: AJOHO ENTERPRISE CO., LTD., Taipei (TW)

(72) Inventors: Chia-Ping MO, Taipei (TW); You-Chi LIU, Taipei (TW)

(21) Appl. No.: 16/006,128

(22) Filed: Jun. 12, 2018

Related U.S. Application Data
(63) Continuation of application No. 15/972,814, filed on May 7, 2018.

(30) Foreign Application Priority Data
Nov. 2, 2017 (TW) 106137962

(51) Int. Cl. H01F 27/32; H01F 27/26; H01F 27/28

(52) U.S. Cl. CPC H01F 27/324; H01F 27/26; H01F 27/28

(57) ABSTRACT

An inductor with conductive adhesive coil conductor includes an insulative plastic block including a block base, a positioning unit with U-shaped plates mounted in the block base and conductors respectively formed of a conductive adhesive on the U-shaped plates by transfer printing and isolated from one another, magnetic conductive components each including a magnetic core mounted in the base and defining therein slots for the passing of the U-shaped plates, and a connection carrier including a substrate and a wire array located on the substrate and electrically bonded with leads of the conductors to create with the magnetic cores a magnetic coil loop capable of providing a magnetic induction effect.

### CROSS REFERENCE TO RELATED APPLICATIONS

This application is a Continuation of co-pending application Ser. No. 15/972,814, filed on May 7, 2018, for which priority is claimed under 35 U.S.C. § 120; and this application claims priority of Application No. 106137962 filed in Taiwan on Nov. 2, 2017 under 35 U.S.C. § 119; the entire contents of all of which are hereby incorporated by reference.

### BACKGROUND OF THE INVENTION

### 1. Field of the Invention

The present invention relates to magnetic technologies and more particularly, to an inductor with conductive adhesive coil conductor, which comprises an insulative plastic block, U-shaped plates of positioning unit mounted in the insulative plastic block and conductors respectively formed of a conductive adhesive on the U-shaped plates by transfer printing and isolated from one another, magnetic cores of magnetic conductive components mounted in the insulative plastic block, and a connection carrier with a wire array thereof electrically bonded with the conductors to create with the magnetic cores a magnetic coil loop capable of providing a magnetic induction effect.

### 2. Description of the Related Art

With the rapid growth of electronic technology, active components and passive components are widely used on internal circuit boards of electronic products. Active components (such as microprocessors or IC chips) can perform arithmetic and processing functions alone. However, passive components (such as resistors, capacitors and inductors, etc.) will maintain their resistance or impedance when the applied current or voltage is changed. In application, active components and passive components are used in information, communication and consumer electronic products to achieve electronic loop control subject to matching of circuit characteristics between components.

Further, an inductor is a passive two-terminal electrical component that stores electrical energy in a magnetic field when electric current flows through it. There are many types of inductors. Inductors often used as electromagnets and transformers are known as coil that can provide high resistance to high frequency. An inductor for use to block higher-frequency alternating current (AC) in an electrical circuit, while passing lower-frequency or direct current (DC) is often referred to as choke or choke ring. Large inductors used with ferromagnetic materials in transformers, motors and generators are called windings.

Inductors according to the electromagnetic induction can be divided into self-induction and mutual induction. When the wire turns wound round the magnetic body (such as magnetic core or ferromagnetic material) increases, the inductance will also become larger. The number of wire turns, the area of the wire turns (loop) and the wire material will affect the inductance size.

An inductor typically consists of an insulated wire wound into a coil around a ferromagnetic magnetic core or a core material with a higher magnetic permeability than the air. When the current flowing through an inductor changes, the time-varying magnetic field induces a voltage in the conductor. However, in actual applications, conventional inductors still have drawbacks as follows:

(1) When the insulated wire is wound into a coil around the ferromagnetic magnetic core, uneven winding of the coil often occurs due to differences in manual winding distribution, and the stray capacitance on the inductor will be difficult to control, resulting in differences between the noise suppression capabilities of same specification coils. Thus, the exact distance between the coil windings must be controlled. Due to small core volume, the manual winding method takes a lot of man-hours. Further, manual winding is not practical for mass production so that the manufacturing cost cannot be reduced.

(2) In order to obtain a larger amount of inductance, the coil windings will generally be overlapped, however, the insulative layer of the enameled wire can easily be scratched during the winding process. Further, overlapping the coil windings of the insulated wire around the ferromagnetic magnetic core will greatly increase the dimension of the inductor, in sequence, the inductor will require a relatively larger circuit board mounting surface to affect the overall circuit layout. When bonding the leads of the coil of the inductor to a circuit board, the large volume of the coil can touch other electronic components on the circuit board, causing coil damage and affecting the electrical characteristics and charge and discharge functions of the inductor.

Therefore, the problems derived from the overall structure and process of conventional inductor winding coil designs must be improved. It is expected to find measures in response to production line and mass production process requirements to improve production efficiency and to reduce costs.

### SUMMARY OF THE INVENTION

The present invention has been accomplished Under the circumstances in view. It is therefore the main object of the present invention to provide an inductor with conductive adhesive coil conductor, which improves the manufacturing quality and yield, achieving the effects of simple structure, ease of installation, high production efficiency and cost effectiveness.

To achieve this and other objects of the present invention, an inductor with conductive adhesive coil conductor comprises an insulative plastic block, a plurality of magnetic conductive components and a connection carrier. The insulative plastic block comprises a block base defining a recessed open chamber in a top side thereof, a positioning unit comprising a plurality of U-shaped plates mounted in the recessed open chamber and a plurality of conductors respectively formed of a conductive adhesive on the U-shaped plates and isolated from one another. The magnetic conductive components are mounted in the recessed open chamber of the block base, each comprising a magnetic core. The magnetic core comprises a plurality of slots cut through opposing top and bottom sides thereof for the passing of the U-shaped plates. The connection carrier comprises a substrate, and a wire array located on the substrate and electrically bonded with the leads of the conductors to create with the magnetic cores a magnetic coil loop capable of providing a magnetic induction effect.

Subject to the design that the U-shaped plates are isolated from one another by the isolation grooves, the conductors formed of the conductive adhesive by transfer printing are precisely shaped and accurately isolated from one another. After bonding of the conductors to the respective contact sets of the wire array, a continuous winding type coil loop is accurately created, improving product yield and reliability and ensuring cost effectiveness.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an exploded view of an inductor with conductive adhesive coil conductor in accordance with the present invention.

FIG. 2 is an oblique elevational view of the insulative plastic block, illustrating conductors formed on the U-shaped plates.

FIG. 3 is a sectional view of the insulative plastic block, illustrating conductors formed on the U-shaped plates.

FIG. 4 is a sectional front view of the inductor with conductive adhesive coil conductor in accordance with the present invention.

FIG. 5 is an elevational view of a transfer-printing equipment according to the present invention.

FIG. 6 is a schematic sectional side view of the transfer-printing equipment before implementation of the conductive adhesive printing process.

FIG. 7 is an elevational view illustrating conductive adhesive covered over the rails of the transfer-printing portion of the bottom mold.

FIG. 8 is a schematic sectional view illustrating the insulative plastic block attached to the bottom mold of the transfer-printing equipment for transfer printing.

FIG. 9 corresponds to FIG. 8, illustrating the insulative plastic block removed from the transfer-printing equipment after transfer printing.

FIG. 10 is a sectional side view of the insulative plastic block after transfer-printed with the conductive adhesive.

### DETAILED DESCRIPTION OF THE PREFERRED EMBODIMENT

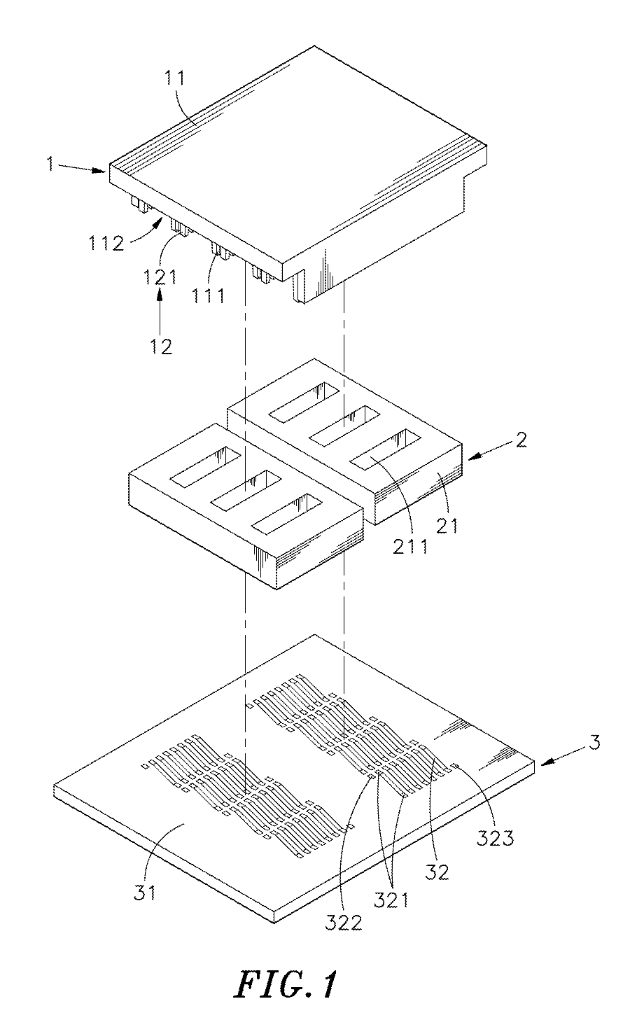

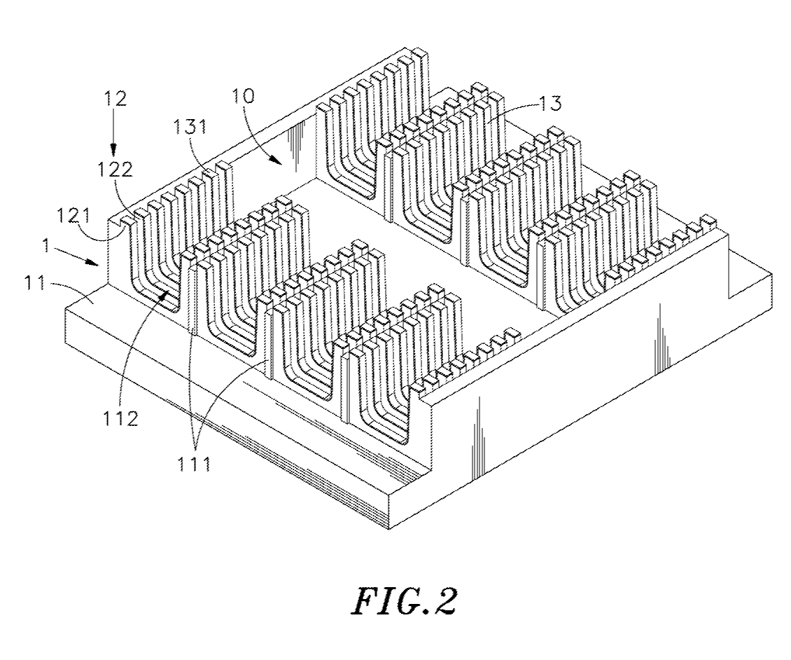

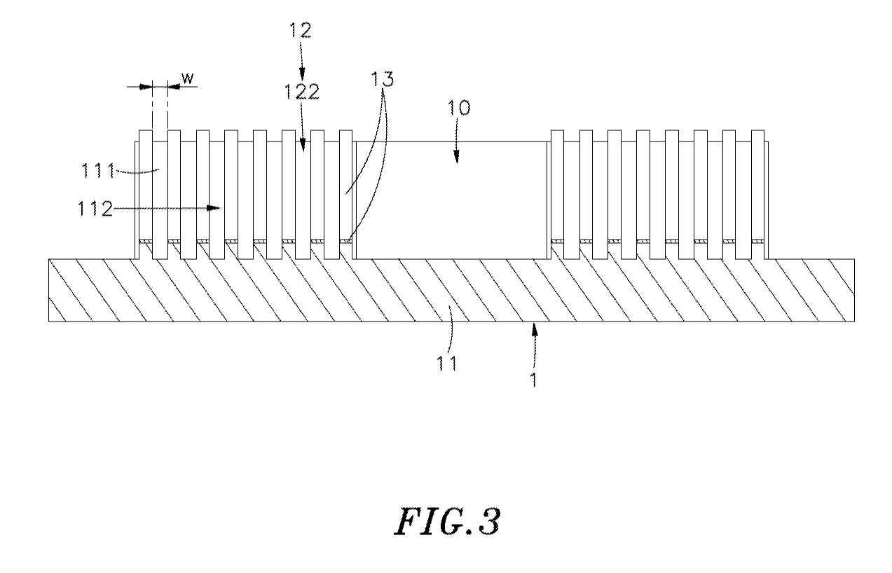

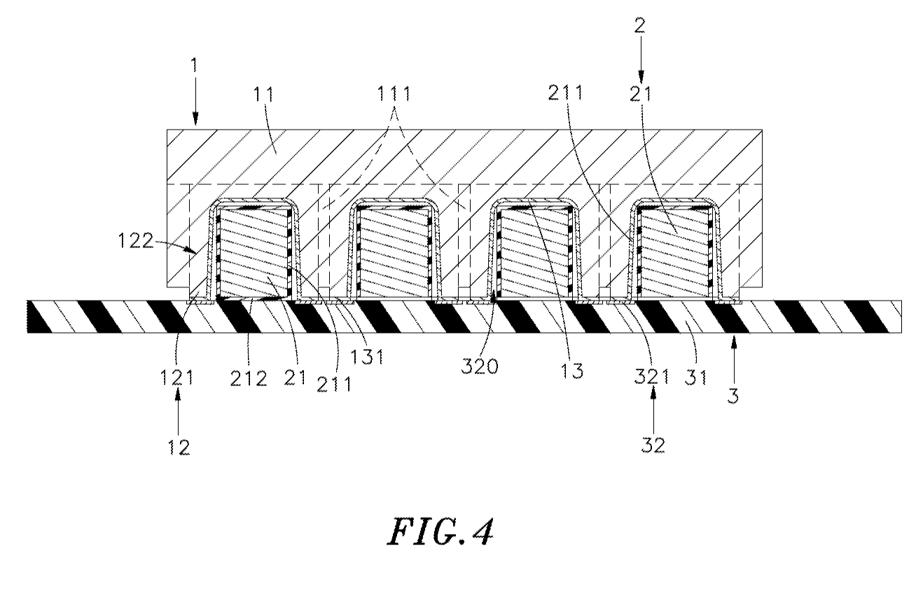

Referring to FIGS. 1-4, an inductor with conductive adhesive coil conductor in accordance with the present invention is shown. As illustrated, the inductor with conductive adhesive coil conductor comprises an insulative plastic block 1, a plurality of magnetic conductive components 2 and a connection carrier 3.

The insulative plastic block 1 comprises a block base 11 made from a plastic material in one piece by injection molding and defining a recessed open chamber 10 in a top side thereof, a plurality of partition plates 111 mounted in the recessed open chamber 10 and arranged in an array and dividing the recessed open chamber 10 into a plurality of parallel channels 112, a positioning unit 12 comprising a plurality of U-shaped plates 121 mounted in each channel 112 with two opposite ends thereof protruding over the block base 11 and an isolation groove 122 of a predetermined width W in the range of 0.5 mm˜2.1 mm defined between each two adjacent U-shaped plates 121 in each channel 112, and conductors 13 respectively formed of a conductive adhesive 130 on the U-shaped plates 121. Each conductor 13 has two opposite ends thereof respectively terminating in a lead 131 and respectively located on the two opposite ends of the respective U-shaped plate 121 outside the block base 11 in a coplanar relationship.

The magnetic conductive components 2 can be made of iron, cobalt, nickel or their alloys, each comprising one or at least one magnetic core 21 in, for example, rectangular shape. The magnetic core 21 comprises a plurality of slots 211 cut through opposing top and bottom sides thereof, and an insulative layer 212 formed of an insulative paint and covered over the surface thereof.

The connection carrier 3 comprises a substrate 31 selected from, but not limited to, the group of bakelite, fiberglass, plastic sheet, ceramic and prepregs, and a wire array 32 made of a copper foil and located on a surface of the substrate 31. The wire array 32 comprises a plurality of contact sets 321 each comprising two staggered rows of contacts, an input side 322 electrically connected with a first contact of each contact set 321, and an output side 323 electrically connected with a last contact of each contact set 321.

In installation, put the magnetic cores 21 of the magnetic conductive components 2 in the channel 112 in the block base 11 of the insulative plastic block 1 to force the U-shaped plates 121 of the positioning unit 12 into the slots 211 of the magnetic cores 21, enabling one lead 131 of each conductor 13 to be disposed in one slot 211 of one respective magnetic core 21 and the other lead 131 of each conductor 13 to be disposed outside the respective magnetic core 21. At this time, the conductors 13 extend through the respective magnetic cores 21 and arranged in an array. In this embodiment, the insulative plastic block 1 and the magnetic conductive components 2 are assembled at first. Further, when mounting the magnetic cores 21 in the block base 11, a glue dispensing technique is employed. However, in actual application, the assembly sequence may also be changed according to the manufacturing process or structural design. For example, the magnetic cores 21 of the magnetic conductive components 2 may be set on the connection carrier 3 first, and then assembled and soldered with the insulative plastic block 1.

In the present preferred embodiment, set the insulative plastic block 1 and the magnetic conductive component 2 on the substrate 31 of the connection carrier 3 to abut the leads 131 of the conductors 13 at the contact sets 321 of the wire array 32 and the solder material (such as solder paste, solder balls or conductive adhesive) in forming a coplane, and then employ surface-mount technology (SMT) to bond the leads 131 of the conductors 13 to the contact sets 321 of the wire array 32, thereby forming the desired inductor (transformer or other inductance component). When an electric current is conducted to the input side 322 of the wire array 32, the electric current goes through an induction area 320 between the contact sets 321 and the conductors 13 to an external circuit via the output side 323. Subject to the magnetic induction effect of the magnetic coil loop formed by the magnetic cores 21 of the magnetic conductive components 2, the inductor of the present invention provides stable inductive effect and rectifying characteristic. The coil structural design of the conductors 13 formed of the conductive adhesive 130 on the positioning unit 12 of the insulative plastic block 1 by curing molding enables the dimension of the inductor to be minimized without increasing the overall height.

Since the direction and density of multiple conductors 13 can be precisely controlled according to actual needs, the inductance components can have the same or similar electrical characteristics to improve the manufacturing quality and yield, achieving the effects of simple structure, ease of installation, high production efficiency and cost effectiveness.

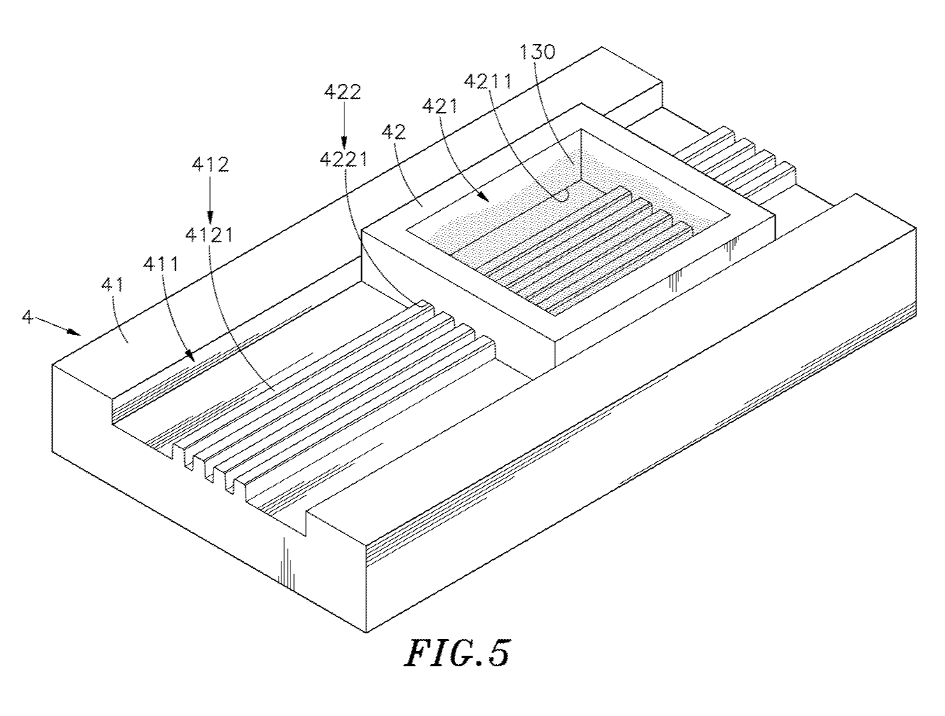

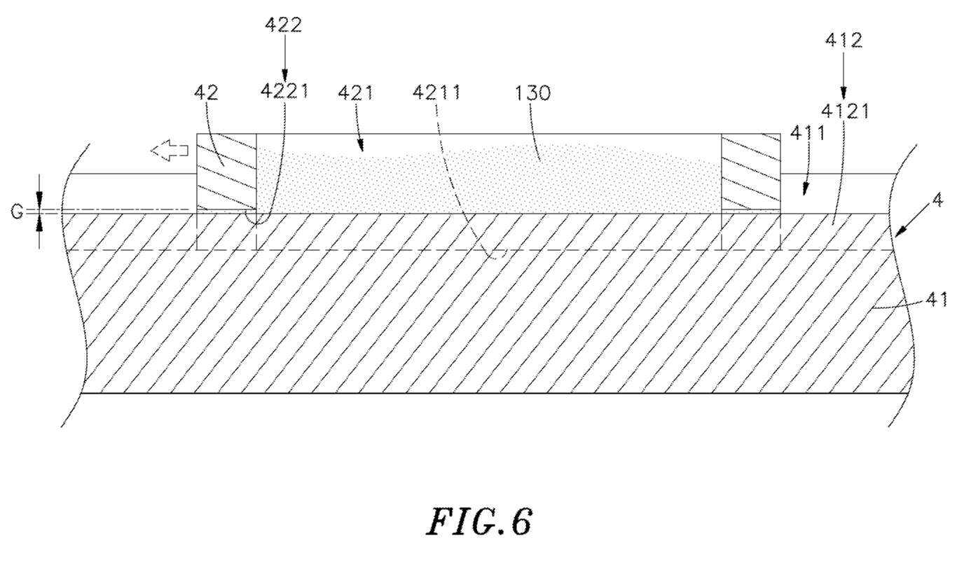

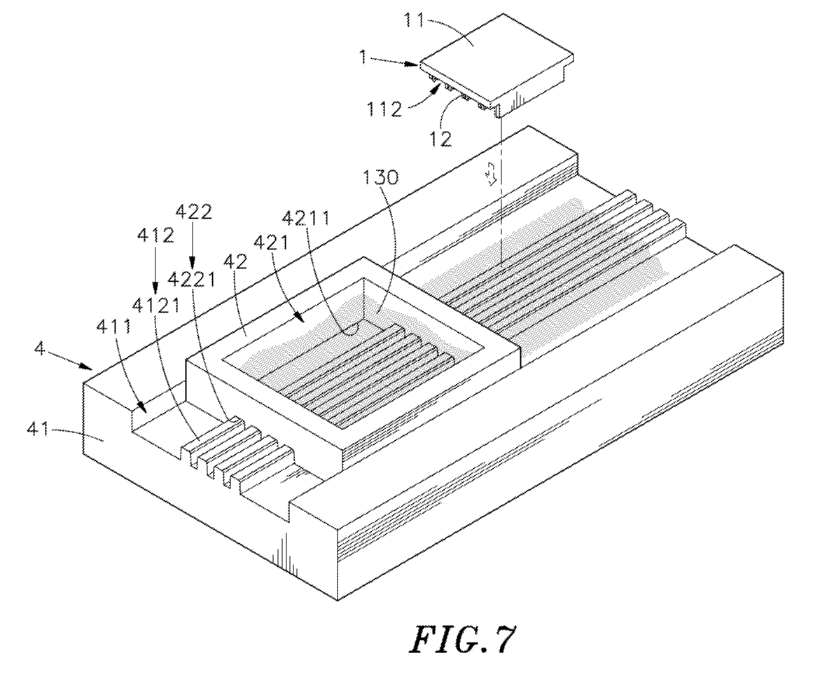

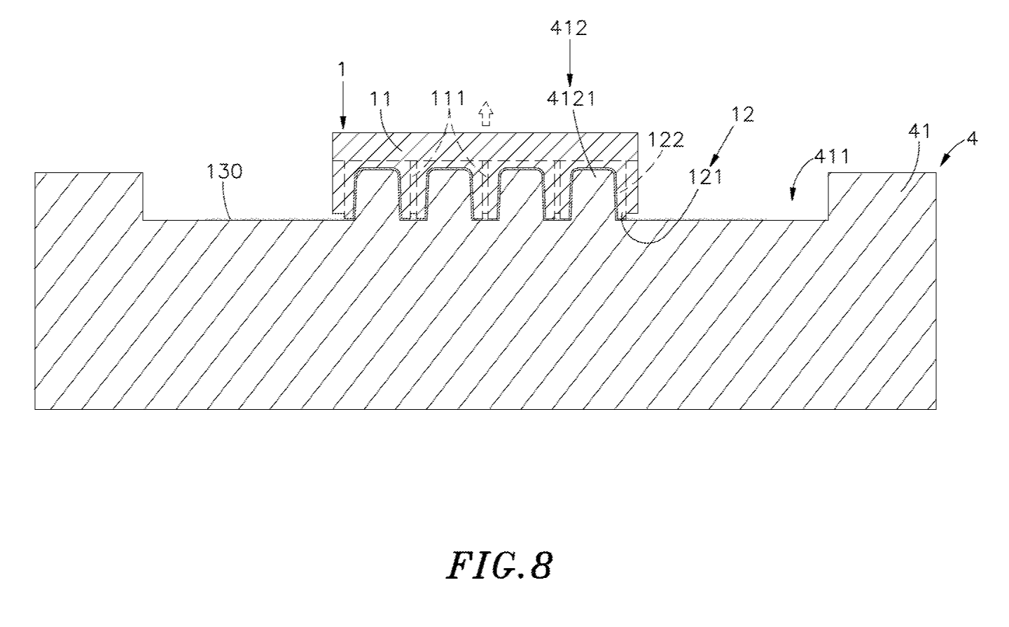

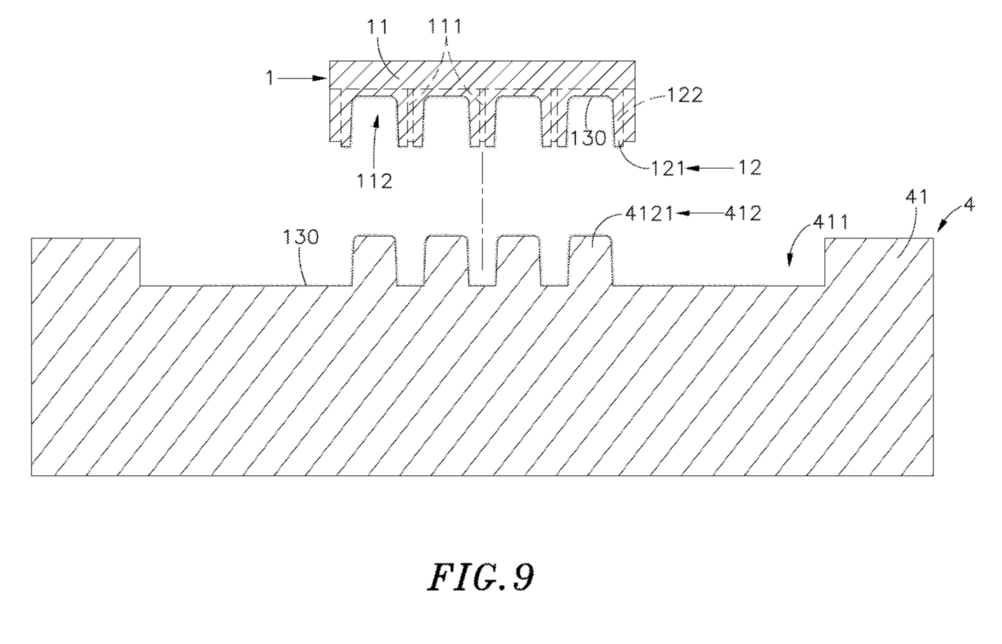

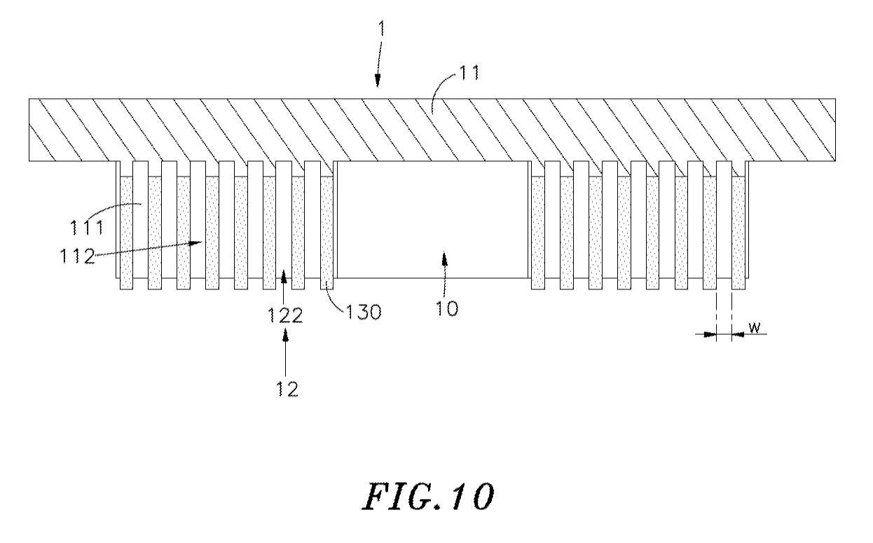

Referring to FIGS. 5-10, when printing the conductive adhesive 130 on a bottom mold 41 of a transfer-printing equipment 4, operate the transfer-printing equipment 4 to move a top mold 42 thereof from a rear side of a position-limiting sliding groove 411 of the bottom mold 41 to an opposing front side thereof to dispense the molten conductive adhesive 130 from an internal storage chamber 421 in the top mold 42 onto a transfer-printing portion 412 of the bottom mold 41 via a dispensing hole 4211 of the top mold 42, enabling rail grooves 4221 of an adhesive applicating portion 422 of the top mold 42 to remove excessive molten conductive adhesive 130 from rails 4121 of the transfer-printing portion 412. Subject to the design of the gap G between each rail groove 4221 and one respective rail 4121, the adhesive applicating portion 422 evenly applies the molten conductive adhesive 130 to the surface of the transfer-printing portion 412, keeping on each rail 4121 a layer of the molten conductive adhesive 130 of thickness equal to the width of the gap G.

Thereafter, invert the insulative plastic block 1 to attach the U-shaped plates 121 of the positioning unit 12 downwardly onto the rails 4121 of the transfer-printing portion 412, enabling the U-shaped plates 121 to be covered by the molten conductive adhesive 130 from the rails 4121, thus, the molten conductive adhesive 130 is transfer-printed to the surface of the U-shaped plates 121. Due to the presence of the width W of the isolation groove 122 between each two adjacent U-shaped plates 121, the molten conductive adhesive 130 on one U-shaped plate 121 is isolated from that on the other U-shaped plates 121. Further, a scraper can be inserted into each isolation groove 122 to remove residual molten conductive adhesive from each U-shaped plate 121. Thereafter, remove the insulative plastic block 1 from the bottom mold 41 for further baking or ultraviolet curing process to cure the conductive adhesive 130 on the U-shaped plates 121, forming the desired conductors 13 with opposing leads 131. Subject to the design of the isolation groove 122 between each two adjacent U-shaped plates 121, the conductors 13 formed of the conductive adhesive 130 by transfer printing are precisely shaped and accurately isolated from one another. After positioning of the insulative plastic block 1 on the connection carrier 3, the conductors 13 are bonded to the respective contact sets 321 of the wire array 32 to create a continuous winding type coil loop, improving product yield and reliability and ensuring cost effectiveness.

As stated above, the U-shaped plates 121 of the positioning unit 12 are arranged in the block base 11 of the insulative plastic block 1 in an array; the conductors 13 are respectively formed of the conductive adhesive 130 on the respective U-shaped plates 121 by transfer printing and curing processes with the leads 131 thereof disposed outside the magnetic cores 21 of the magnetic conductive components 2 and bonded with the wire array 32 of the connection carrier 3 to create magnetic coil loop capable of providing a magnetic induction effect. Since the U-shaped plates 121 are isolated from one another by the isolation grooves 122, the conductors 13 formed of the conductive adhesive 130 by transfer printing are precisely shaped and accurately isolated from one another. After bonding of the conductors 13 to the respective contact sets 321 of the wire array 32, a continuous winding type coil loop is accurately created, improving product yield and reliability and ensuring cost effectiveness.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. An inductor with conductive adhesive coil conductor, comprising:
an insulative plastic block comprising a block base defining a recessed open chamber in a top side thereof, a positioning unit, said positioning unit comprising a plurality of U-shaped plates mounted in said recessed open chamber, a predetermined width defined between each two adjacent U-shaped plates and a plurality of conductors respectively formed of a conductive adhesive on said U-shaped plates and isolated from one another, one lead of each conductor to be disposed in one slot of one respective magnetic core and the other lead of each conductor to be disposed outside the respective magnetic core;
a plurality of magnetic conductive components mounted in said recessed open chamber of said block base, each said magnetic conductive component comprising one or at least one magnetic core, said magnetic core comprising a plurality of slots cut through opposing top and bottom sides thereof for the passing of said U-shaped plates; and
a connection carrier comprising a substrate, and a wire array located on said substrate and electrically bonded with said leads of said conductors to create with said magnetic cores a magnetic coil loop capable of providing a magnetic induction effect.

2. The inductor with conductive adhesive coil conductor as claimed in claim 1, wherein said insulative plastic block further comprises one or at least one partition plates mounted in said recessed open chamber and arranged in an array and dividing said recessed open chamber into a plurality of parallel channels for accommodating said U-shaped plates; said positioning unit further comprises an isolation groove defined between each two adjacent said U-shaped plates in each said channel; said magnetic cores of said magnetic conductive component are respectively mounted in said channels in said block base; each said conductor comprises two opposing leads disposed outside one respective said magnetic core.

3. The inductor with conductive adhesive coil conductor as claimed in claim 2, wherein each said U-shaped plate has two opposite ends thereof protruding over said block base; each said conductor has the said leads thereof respectively located on the two opposite ends of the respective said U-shaped plate outside said block base.

4. The inductor with conductive adhesive coil conductor as claimed in claim 3, wherein a wire array of a connection carrier comprises a plurality of contact sets located on a substrate; an insulative plastic block and a magnetic conductive component are mounted on said substrate; said leads of said conductors are respectively electrically bonded to said contact sets of said wire array to create with said magnetic core said magnetic coil loop.

5. The inductor with conductive adhesive coil conductor as claimed in claim 4, wherein said leads of said conductors are respectively electrically bonded to said contact sets of said wire array in a coplanar relationship using surface-mount technology.

6. The inductor with conductive adhesive coil conductor as claimed in claim 1, wherein said positioning unit further comprises an isolation groove defined between each two adjacent said U-shaped plates in the range of 0.5 mm˜2.1 mm.

7. The inductor with conductive adhesive coil conductor as claimed in claim 1, wherein said conductors are respectively formed of a conductive adhesive on said U-shaped plates by transfer printing.

8. The inductor with conductive adhesive coil conductor as claimed in claim 1, wherein said magnetic core of each said magnetic conductive component further comprises an insulative layer covered over the surface thereof.
